(19) United States
(12) Patent Application Publication
(10) Pub. No.: US 2004/0155090 A1
(43) Pub. Date: Aug. 12, 2004

(54) Device in the feeding of welding wire

(76) Inventor: Bernt-Inge B.-Jensen, Rexegatan (SE)

Correspondence Address: HARNESS, DICKEY & PIERCE, P.L.C., P.O. BOX 8910, RESTON, VA, 20195, US

(21) Appl. No.: 10/475,494

(22) PCT Filed: Jan. 15, 2002
(86) PCT No.: PCT/SE02/00055

(30) Foreign Application Priority Data
May 18, 2001 (SE) 0101749-0

(51) Int. Cl. B23K 37/00

(52) U.S. Cl. 228/41

(57) ABSTRACT

A device and a method, as well as use thereof, in the feeding of welding wire, said device and method designed to prevent deformities from forming in the welding wire (2) during the feeding of welding wire. A first end of the welding wire (2) in one container (3) is connectable to a wire guide (1). A wire-orientation runner (11) is arranged on the front end portion as seen in the direction of wire feed, of the welding wire (2) inside the container (3), said runner arranged to advance, during wire feed, along the welding wire (2) as the wire feed progresses

### TECHNICAL FIELD OF INVENTION

The present invention relates to a device and a method for the feeding of welding wire, said device and method designed to prevent deformities from forming in the welding wire. In addition, the present invention relates to the use of the device in conjunction with uninterrupted changeover of wire from a first container holding welding wire to a second container holding welding wire.

### TECHNICAL BACKGROUND OF THE INVENTION

It is most important that welding operations can be performed without interruptions, particularly when structural parts requiring extremely high-quality welding joints are to be welded together. Feeding the wire in a continuous manner avoids time-consuming and complex wire exchanges, which require feed-in of a fresh wire through the wire guide to the welding machine. Interruptions of the feed-in of a fresh wire into the wire guide cause considerable problems, particularly when several welding machines work together.

In the course of the welding process, the wire is fed from the container to the welding machine via a wire guide, the container being emptied gradually. This sequence is illustrated in FIGS. 1A and 1B in conjunction with the uninterrupted changeover from a first container holding welding wire to a second container holding welding wire. When the supply of wire inside the first container runs out, the wire feed continues without interruptions in that the withdrawal of wire is transferred automatically to the second container. A problem may arise, however, as the end part of the welding wire in the first container is being withdrawn therefrom. A problem of this nature may also arise already during the withdrawal of wire from the first container, as a loop may then form, which is gradually tightened as the wire feed progresses. If it comes to the worst, a knot-like deformity develops in the welding wire, referred to in the following as a “kink”. FIGS. 1C and 1D very schematically show examples of such development. Deformities of this kind hamper the wire feed and cause interruptions of the welding process. Also sharp bending of the welding wire involves risks of undesired welding interruptions, since the welding wire may obstruct the wire-guide or the welding-machine operation.

Under unhappy circumstances, sharp bends or “kinks” in the welding wire may arise as the wire is being withdrawn from a container holding welding wire. Such “kinks” or similar deformations could arise, for instance when the welding wire, in wound condition inside the container, leaves the reel in an uncontrolled manner. Should this happen, the welding-wire feed is obstructed and the welding process is interrupted.

### SUMMARY OF THE INVENTION

The object of the present invention is to counteract by means of a simple device the formation of “kinks” in and sharp bending of the welding wire as may arise when the wire is being paid out in conjunction with welding operations, particularly in connection with the automatic changeover of the welding-wire withdrawal from a first container holding welding wire to a second container holding welding wire.

This object is achieved by means of a device of the kind defined in the introduction, which is characterised in that a wire-orientation runner is arranged on the leading end part, as seen in the direction of wire feed, of the welding wire placed inside the container, said runner arranged to advance, during wire feed, along the welding wire as the wire feed progresses.

Preferably, the runner is a solid body and it is formed with a welding-wire passage. The forward end part of the runner, as seen in the direction of wire feed, is configured so as to form a slide-off surface for the welding wire.

In a preferred embodiment, the runner is essentially pear-shaped and the welding-wire passage extends in the lengthwise direction of the runner. The inlet to the welding-wire passage essentially is a circular aperture.

One object of the present invention likewise is to suggest a method for withdrawal of wire from a container holding welding wire in conjunction with wire feed through a wire guide to a welding machine, preferably in conjunction with uninterrupted changeover from a first container holding welding wire to a second container holding welding wire.

This method is characterised by the steps (without limitation as to the mutual order) of connecting via a wire guide, a first end of a welding wire in a first container holding welding wire to the wire feed mechanism of a welding machine, and arranging a wire-orientation runner on the leading end part, as seen in the direction of wire feed, of the welding wire placed inside the first container.

In the case of feeding welding wire with uninterrupted changeover of the withdrawal of welding wire from a first container holding welding wire to a second container holding welding wire the runner is made to automatically accompany the welding wire from the first to the second container holding welding wire, when the welding wire inside the first container holding welding wire is used up.

Additional characteristics and advantages of the invention will become apparent from the following description and accompanying claims.

### BRIEF DESCRIPTION OF THE DRAWINGS

The invention will be described in more detail in the following with reference to the accompanying drawings, wherein

FIGS. 1A-D illustrate a prior-art wire feed sequence.

FIG. 2 is a schematic representation of the device in accordance with the invention.

FIGS. 3A-B illustrate a wire feed sequence in accordance with the present invention.

FIG. 4 is a cross-sectional view of a wire-orientation runner in accordance with the invention.

FIGS. 5A-D are views showing a sequence according to which the wire-orientation runner of FIG. 4 prevents deformities from forming in the welding wire.

### DETAILED DESCRIPTION OF PREFERRED EMBODIMENTS

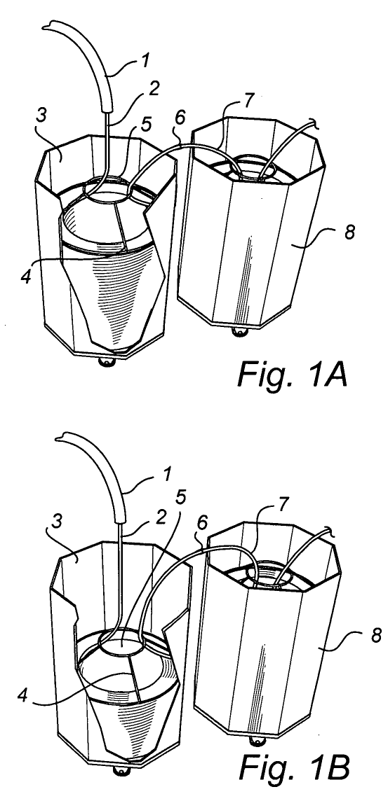

FIG. 1 shows a conventional wire-feed sequence in welding operations using an endless welding wire. A first end of a welding wire 2 is fed to a wire guide 1. The welding wire 2 is stored in a suitable manner in wound condition and packaged inside a container 3. A holding-down means 4 is placed on top of the reel of wound welding wire in order to keep the welding wire 2 in place inside the container 3. The welding wire 2 is withdrawn from the container 3 through an opening 5 formed in the holding-down means 4. Preferably by means of a welding joint 6, the trailing end of the welding wire 2 is joined to the exiting leading end of a second welding wire 7. The welding wire 7 preferably is wound and packaged inside a second container 8 in an identical manner to welding wire 2. As the welding process progresses, the welding wire 2 is fed through the wire guide 1, and the amount of welding wire inside the container 3 is reduced gradually (fig 1B). The sequence of steps occurring when the trailing part of the welding wire 2 in which a loop 9 has formed is to be withdrawn from the container 3, is shown in FIG. 1C. As the welding-wire feed progresses, the loop 9 is tightened more and more. As a result, the welding wire 2 may bend sharply, which in the most serious case may lead to the formation of a “kink” 10, as shown in FIG. 1D. The sharp bend of a “kink” 10 in the welding wire results in interruption of the wire feed and consequently in interruption of the welding process. In some cases, welding interruptions may have serious consequences of a practical and economical nature.

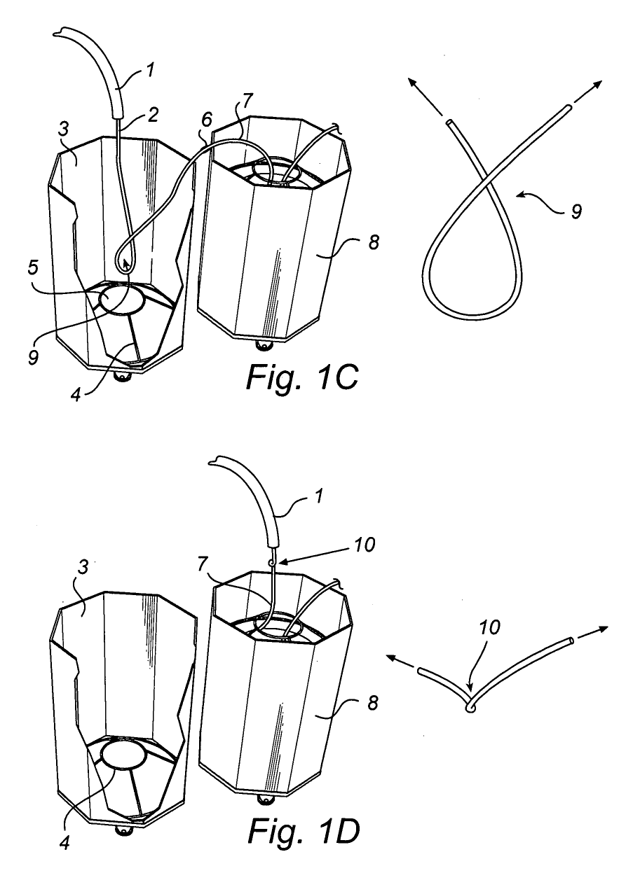

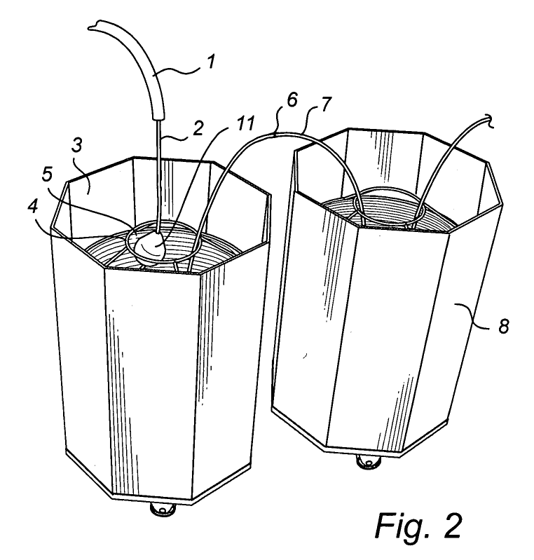

FIG. 2 illustrates a device in accordance with the invention. This device differs from the prior art in that a wire-orientation runner 11, in the following referred to as a runner, is placed on the leading end part, as seen in the direction of wire feed, of the welding wire 2. As welding wire 2 is being withdrawn from the container 3, the runner 11 will advance along the welding wire 2. When the welding wire 2 inside the container 3 is used up (FIG. 3A) and the wire feed continues uninterruptedly with the welding wire 7, the runner 11 accompanies the wire across the wire joint 6, and in addition it prevents undesired deformities from forming in the wire (FIG. 3B).

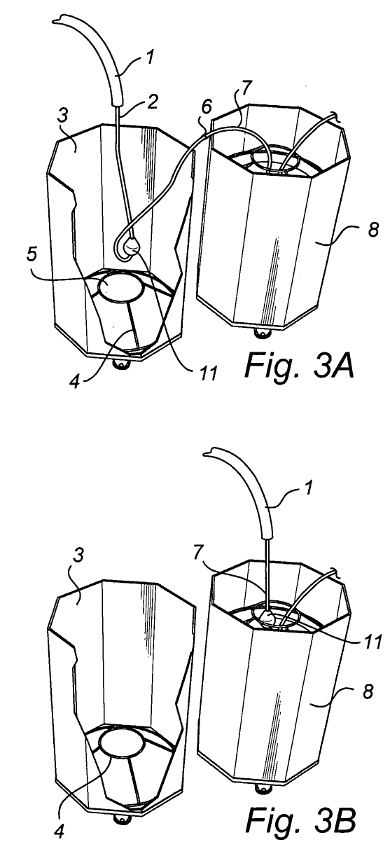

The runner 11 preferably is a solid body and it is formed with a welding-wire passage 12, as shown in FIG. 4. Preferably, the runner 11 is manufactured from a material having a certain weight while at the same time being sufficiently lightweight to prevent the runner 11 from causing undesired defects on the welding wire 2, 7. In addition, the material should not have too high a braking effect but allow the runner 11 to advance comparatively easily along the welding wire 2, 7. Examples of materials of this kind are wood, metal and certain types of plastic, but the invention does not exclude the choice of other materials.

The inlet 13 to the welding-wire passage 12 should be of a nature preventing the welding wire 2, 7 from becoming stuck in the inlet 13 during the wire feed. Preferably, the inlet 13 is an essentially circular aperture. In a preferred embodiment, the welding-wire passage is a circular bore extending in the lengthwise direction of the runner 11. The welding-wire passage 12 could, however, have any desired geometrical configuration, provided it is of a nature allowing the runner 11 to move along the welding wire 2, 7 without becoming stuck or being exposed to too strong braking forces during the wire feed.

The outlet 14 from the welding-wire passage 12 preferably has a configuration identical to that of the inlet 13, but it could be given other, different geometrical shapes.

The external shape of the runner 11 could vary but it should include a slide-off surface 15 for the welding wire 2, 7. In one preferred embodiment, the forward end part of the runner 11 as seen in the direction of wire feed, is formed with an external surface that tapers gently towards the welding-wire passage, said tapering surface thus constituting said slide-off surface 15. The external shape of the runner preferably is that of a pear.

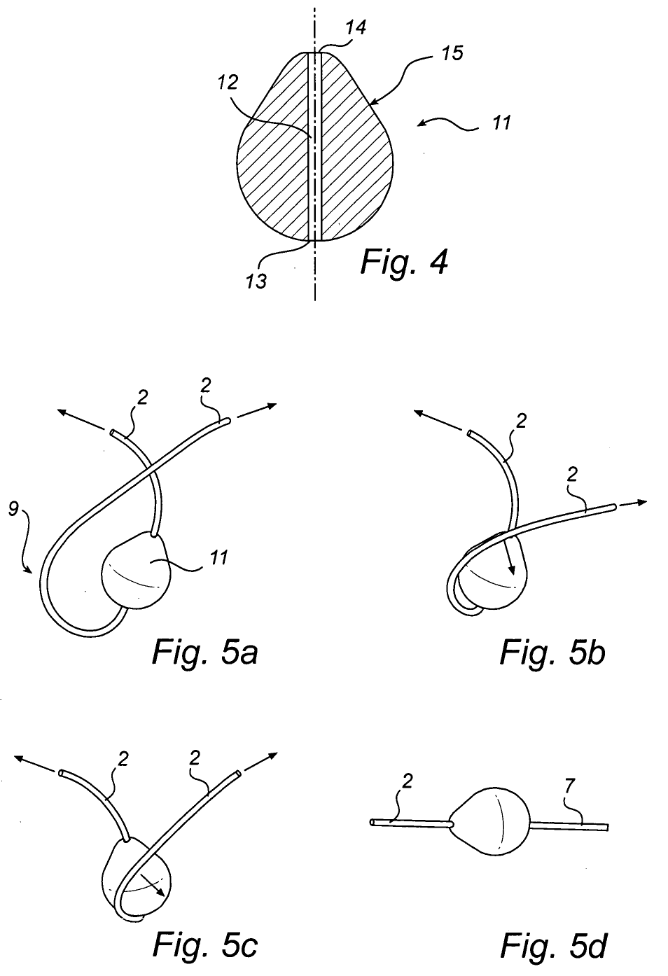

The wire feed sequence when welding wire 2 is used up and the wire feed continues uninterruptedly with welding wire 7 is illustrated in FIG. 5. FIG. 5A illustrates what happens when a loop 9 forms in the welding wire. Thanks to the inventive object, the loop 9 will not be tightened, however, and consequently no “kink” will form. The part of the welding wire 2 that is joined to the welding wire 7 will slide in contact with the external surface of the runner 11 (FIGS. 5B and 5C) and thus be moved sideways relative to the exiting wire part instead of sliding against the welding wire 2 as in the case shown in FIGS. 1C-1D. The wire feed thus will continue without interruptions and the welding wire 7 may be fed unimpededly through the runner 11 (FIG. 5D) and further through the wire guide 1. The slide-off surface 15 on the runner 11 adjacent the outlet 14 preferably is configured in a manner allowing the welding wire to slide off without becoming stuck.

As will be appreciated numerous modifications of the embodiment of the invention described above are possible within the scope of the invention as the latter is defined in the appended claims. For example, as mentioned previously the runner may be manufactured from other materials and be given other shapes than shown. Also, the welding-wire passage could have various sizes and shapes and could have an extension relative to the runner that differs from the one shown in the drawings. The inlet and the outlet could have identical or dissimilar geometrical shapes. Although the illustrated embodiment describes changeover of the wire feed from a first to a second container, it should be appreciated that the invention also includes arrangements involving wire feed from one container only.

1. A device in the feeding of welding wire for preventing deformities from forming in a welding wire (2) during the wire feed, wherein a first end of the welding wire (2) in one container (3) is connectable to a wire guide (1), characterised in that a wire-orientation runner (11) is arranged on the leading end part, as seen in the direction of wire feed, of the welding wire (2) placed inside the container (3), said runner arranged to advance, during wire feed, along the welding wire (2, 7) as the wire feed progresses.

2. A device as claimed in claim 1, characterised in that the trailing end of the welding wire (2) in a first container (3) holding welding wire is interconnected with the leading end of the welding wire (7) in a second container (8) holding welding wire, for continuous withdrawal of welding wire from wire-holding containers arranged one after the other.

3. A device as claimed in claim 1 or claim 2, wherein said runner (11) is formed with a welding-wire passage (12).

4. A device as claimed in any one of claims 1-3, wherein said runner (11) is a solid body.

5. A device as claimed in any one of the preceding claims, wherein the front end portion of said runner (11) as seen in the direction of wire feed is configured to form a slide-off surface (15) for said welding wire (2, 7).

6. A device as claimed in any one of the preceding claims, wherein the front end portion of said runner (11) as seen in the direction of wire feed has a shape that softly tapers towards the welding-wire passage (12), thus forming said slide-off face (15).

7. A device as claimed in any one of the preceding claims, wherein said runner (11) is essentially pear-shaped.

8. A device as claimed in any one of the preceding claims, wherein the welding-wire passage (12) extends in the longitudinal direction of the runner (11).

9. A device as claimed in any one of the preceding claims, wherein the inlet (13) to the welding-wire passage (12) is an essentially circular aperture.

10. A wire-orientation runner, characterised in that the runner (11) is formed with a welding-wire passage (12).

11. A wire-orientation runner as claimed in claim 10, wherein said runner (11) is a solid body.

12. A wire-orientation runner as claimed in claim 10 or 11, wherein the front end portion of said runner (11) as seen in the direction of wire feed is configured to form a slide-off surface (15) for said welding wire (2, 7).

13. A wire-orientation runner as claimed in any one of claims 10-12, wherein the front end portion of said runner (11) as seen in the direction of wire feed has a shape that softly tapers towards the welding-wire passage (12), thus forming said slide-off surface (15).

14. A wire-orientation runner as claimed in any one of claims 10-13, wherein said runner (11) is essentially pear-shaped.

15. A wire-orientation runner as claimed in any one of claims 10-14, wherein the welding-wire passage (12) extends in the longitudinal direction of the runner (11).

16. A wire-orientation runner as claimed in any one of claims 10-15, wherein the inlet (13) to the welding-wire passage (12) is an essentially circular aperture.

17. A method for feeding welding wire, comprising the steps of:
connecting a first end of a welding wire (2) in a first container (3) holding welding wire to a wire guide (1) and
arranging a wire-orientation runner (11) on the leading end part, as seen in the direction of wire feed, of the welding wire (2) placed inside the first container (3).

18. A method for feeding welding wire as claimed in claim 17, wherein feeding of welding wire comprises uninterrupted changeover of the welding-wire withdrawal from a first container holding welding wire to a second container holding welding wire, said method further comprising the steps of:
interconnecting a second end of the welding wire (2) in the first container (3) holding welding wire and the first end of a welding wire (7) in a second container (8) holding welding wire, and
allowing said runner (11) to automatically accompany the welding wire from the first to the second container holding welding wire, when the supply of welding wire in said first container holding welding wire runs out.

19. A method as claimed in claim 17 or claim 18, wherein said runner (11) is formed with a welding-wire passage (12).

20. A method as claimed in any one of claims 17-19, wherein said runner (11) is a solid body.

21. A method as claimed in any one of claims 17-20, wherein the front end portion of said runner (11) as seen in the direction of wire feed is configured to form a slide-off surface (15) for said welding wire (2, 7).

22. A method as claimed in any one of claims 17-21, wherein the front end portion of said runner (11) as seen in the direction of wire feed has a shape that softly tapers towards the welding-wire passage (12), thus forming said slide-off surface (15).

23. A method as claimed in any one of claims 17-22, wherein said runner (11) is essentially pear-shaped.

24. A method as claimed in any one of claims 17-23, wherein the welding-wire passage (12) extends in the longitudinal direction of the runner (11).

25. A method as claimed in any one of claims 17-24, wherein the inlet (13) to the welding-wire passage (12) is an essentially circular aperture.

26. The use of a wire-orientation runner arranged to move along the welding wire as claimed in any one of the preceding claims, in feeding welding wire in conjunction with uninterrupted changeover of the withdrawal of welding wire from a first container (3) holding welding wire to a second container (8) holding welding wire, wherein a first end of the welding wire (2) in the first container (3) is connectable to a wire guide (1) and a second end of the welding wire (2) in the first container (3) holding welding wire is connectable to a first end of the welding wire (7) in the second container (8) holding welding wire.
